(19) United States
(12) Patent Application Publication
(10) Pub. No.: US 2022/0312229 A1
(43) Pub. Date: Sep. 29, 2022

(54) METHODS AND DEVICES FOR WIRELESS COMMUNICATION

(71) Applicant: Telefonaktiebolaget LM Ericsson (publ), Stockholm (SE)

(72) Inventors: Rui FAN, Beijing (CN); Chi Chuen YUEN, Stockholm (SE)

(73) Assignee: Telefonaktiebolaget LM Ericsson (publ), Stockholm (SE)

(21) Appl. No.: 17/619,718

(22) PCT Filed: Jun. 17, 2019
(86) PCT No.: PCT/CN2019/091509

§ 371 Date: Dec. 16, 2021

(51) Int. Cl. H04W 24/02; H04W 24/04; H04W 24/10; H04B 17/336; H04L 5/00

(52) U.S. Cl. CPC H04W 24/02; H04W 24/04; H04W 24/10; H04B 17/336; H04L 5/0053

(57) ABSTRACT

The present disclosure provides a method (200) at a network device. The method (200) includes: obtaining (210) a probability distribution of a parameter that indicates received signal quality for terminal devices in a cell associated with the network device; and determining (220), based at least on the probability distribution, one or more thresholds of the parameter for classifying the terminal devices into CE levels.

### TECHNICAL FIELD

The present disclosure relates to wireless communication, and more particularly, to coverage enhancement in wireless communication.

### BACKGROUND

Narrowband Internet of Things (NB-IoT) is an Internet of Things (IoT) technology based on cellular network to enable a wide range of IoT devices and services, especially devices deployed in deep coverage. NB-IoT defines a plurality of coverage enhancement (CE) levels (typically, three CE levels) to meet different radio channel conditions. Specifically, the coverage area of a cell can be divided into different CE levels each corresponding to a maximum coupling loss (MCL). A lower CE level may correspond to a smaller MCL and a smaller repetition number for transmission, while a higher CE level may correspond to a larger MCL and a larger repetition number, so as to ensure the quality of service.

As an example, there may be three CE levels, CE0, CE1 and CE2 in a cell. CE0 may correspond to an MCL of 144 dB and a repetition number of 1, CE1 may correspond to an MCL of 154 dB and a repetition number of 8, and CE2 may correspond to an MCL of 164 dB and a repetition number of 32. Terminal devices having a pathloss lower than 144 dB may be at CE0, terminal devices having a pathloss between 144 dB and 154 dB may be at CE1, and terminal devices having a pathloss between 154 dB and 164 dB may be at CE2.

With such a configuration, terminal devices having a larger pathloss may experience more repetitions of transmission to ensure the quality of service. However, there may be a waste of resources in the cell due to the repetitions caused by inappropriate CE levels.

### SUMMARY

Methods, devices, computer-readable storage media and computer program products are provided to enable an efficient use of resources in a cell.

In a first aspect of the present disclosure, a method at a network device is provided. The method may include obtaining a probability distribution of a parameter that indicates received signal quality for terminal devices in a cell associated with the network device; and determining, based at least on the probability distribution, one or more thresholds of the parameter for classifying the terminal devices into CE levels.

According to an embodiment, the determining step may further include determining, based at least on the probability distribution, repetition numbers each associated with one of the CE levels.

According to an embodiment, the one or more thresholds of the parameter and the repetition numbers may be determined in such a way that a sum of repetition numbers for the terminal devices in the cell is minimized for a predetermined number of the CE levels.

According to an embodiment, obtaining the probability distribution of the parameter may comprise at least one of: obtaining the probability distribution of the parameter in downlink transmission; and obtaining the probability distribution of the parameter in uplink transmission.

According to an embodiment, the one or more thresholds of the parameter and the repetition numbers may be determined based on: the probability distribution of the parameter in downlink transmission; and/or the probability distribution of the parameter in uplink transmission.

According to an embodiment, the method may be repeated regularly to update the one or more thresholds of the parameter and the repetition numbers.

According to an embodiment, the parameter may be Signal to Interference plus Noise Ratio (SINR).

According to an embodiment, the parameter may be downlink SINR, and the probability distribution of the downlink SINR may be obtained based on a Channel Quality Indicator (CQI) reported by each of the terminal devices.

According to an embodiment, the parameter may be downlink SINR, and the probability distribution of the downlink SINR may be obtained based on one or more Acknowledgement (ACK) or Negative Acknowledgement (NACK) messages from each of the terminal devices.

According to an embodiment, the parameter may be uplink SINR, and the probability distribution of the uplink SINR may be obtained based on a received signal power and a noise and interference power for each of the terminal devices measured by the network device.

According to an embodiment, the method may further include determining one or more thresholds of Reference Signal Received Power (RSRP) corresponding to the one or more thresholds of SINR.

According to an embodiment, the one or more thresholds of RSRP may be determined according to a relationship between RSRP and SINR for the terminal devices in the cell. The relationship may be derived based at least on information reported by the terminal devices in the cell.

According to an embodiment, the parameter may be RSRP, and the probability distribution of RSRP may be obtained based on at least one of RSRP reported by each of the terminal devices and Power Headroom reported by each of the terminal devices.

According to an embodiment, a larger repetition number may be associated with a CE level having worse signal quality.

According to an embodiment, the network device may be configured to support NB-IoT.

According to an embodiment, the method may further include transmitting information related to the one or more thresholds of the parameter and the repetition numbers to the terminal devices in the cell.

In a second aspect of the present disclosure, a network device is provided. The network device may include a processor and a memory configured to store instructions. The instructions, when executed by the processor, cause the network device to perform the method according to the above first aspect.

In a third aspect of the present disclosure, a computer readable storage medium is provided. The computer readable storage medium has instructions stored thereon, which, when executed by a processor of a network device, cause the network device to perform the method according to the above first aspect.

With the embodiments of the present disclosure, thresholds for setting CE levels can be determined based on the probability distribution of a signal quality related parameter for the terminal devices in a cell, instead of based on fixed settings. In this way, the resources in the cell can be utilized in an efficient manner.

### BRIEF DESCRIPTION OF THE DRAWINGS

The above and other objects, features and advantages will be more apparent from the following description of embodiments with reference to the figures, in which:

FIG. 1 is a schematic diagram illustrating exemplary CE levels in a cell according to embodiments of the present disclosure;

FIG. 2 is a flowchart illustrating a method at a network device according to embodiments of the present disclosure;

FIG. 3 is a schematic diagram illustrating an exemplary probability distribution of SINR in a cell according to embodiments of the present disclosure;

FIG. 4 is a schematic diagram illustrating an example of optimizing the thresholds for CE levels according to embodiments of the present disclosure;

FIG. 5 is a schematic diagram illustrating an exemplary curve of SINR versus RSRP in a cell according to embodiments of the present disclosure;

FIG. 6 is a block diagram illustrating an exemplary network device according to embodiments of the present disclosure;

FIG. 7 is a block diagram illustrating an exemplary apparatus that can perform the method of FIG. 2 according to embodiments of the present disclosure;

FIG. 8 schematically illustrates a telecommunication network connected via an intermediate network to a host computer;

FIG. 9 is a generalized block diagram of a host computer communicating via a base station with a user equipment over a partially wireless connection; and

FIGS. 10 to 13 are flowcharts illustrating methods implemented in a communication system including a host computer, a base station and a user equipment.

### DETAILED DESCRIPTION

As used herein, the term “wireless communication network” refers to a network following any suitable wireless communication standards, such as NR, LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), LTE, and/or other suitable 1G, 2G, 2.5G, 2.75G, 3G, 4G, 4.5G, 5G, 6G communication protocols; wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network device” or “network node” refers to a device in a communication network via which a terminal device accesses the network and receives services therefrom. Examples of the network device may include a base station (BS), an access point (AP), or any other suitable device in the wireless communication network. The BS may be, for example, a node B (NodeB or NB), an evolved NodeB (eNodeB or eNB), a next generation NodeB (gNodeB or gNB), a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes, positioning nodes or the like. More generally, however, the network device may represent any suitable device (or group of devices) capable, configured, arranged, and/or operable to enable and/or provide a terminal device access to the wireless communication network or to provide some service to a terminal device that has access to the wireless communication network.

The term “terminal device” refers to any end device that can access a wireless communication network and receive services therefrom. By way of example and not limitation, the terminal device may refer to a mobile terminal, a user equipment (UE), or other suitable devices. The UE may be, for example, a Subscriber Station (SS), a Portable Subscriber Station, a Mobile Station (MS), or an Access Terminal (AT). The terminal device may include, but not limited to, portable computers, desktop computers, image capture terminal devices such as digital cameras, gaming terminal devices, music storage and playback appliances, mobile phones, cellular phones, smart phones, tablets, personal digital assistants (PDAs), wearable devices, vehicle-mounted wireless terminal devices, wireless endpoints, or the like.

In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. As a further example, a UE may represent a device that is intended for sale to, or operation by, a human user but that may not initially be associated with a specific human user.

As yet another example, in an Internet of Things (IoT) scenario, a terminal device may represent a machine or other device that performs monitoring, sensing and/or measurements, and transmits the results of such monitoring, sensing and/or measurements to another terminal device and/or network equipment. The terminal device may in this case be a machine-to-machine (M2M) device, which may in a 3GPP context be referred to as a machine-type communication (MTC) device.

As used herein, a downlink transmission refers to a transmission from a network device to a terminal device, and an uplink transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

In the existing solution of coverage enhancement, fixed MCLs are used as thresholds (i.e., pathloss thresholds) to classifying terminal devices in a cell into different CE levels. However, this solution does not take the actual deployment of the cell into consideration and may cause a waste of resources in the cell.

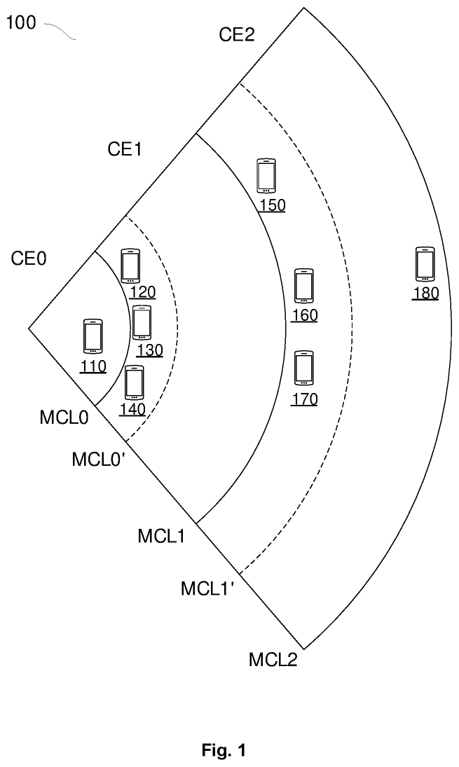

Take FIG. 1 as an example. FIG. 1 is a schematic diagram illustrating exemplary CE levels in a cell according to embodiments of the present disclosure.

As shown in FIG. 1, the cell 100 is divided into three CE levels, CE0, CE1 and CE2, according to MCL0, MCL1 and MCL2 as indicated by the solid curves. In particular, UE 110 having a pathloss less than MCL0 are classified as CE0, UEs 120, 130 and 140 having pathlosses between MCL0 and MCL1 are classified as CE1, and UEs 150, 160, 170 and 180 having pathlosses between MCL1 and MCL2 are classified as CE2. Each CE level corresponds to a different repetition number. In this example, CE0, CE1 and CE2 may correspond to repetition numbers of 1, 8 and 32, respectively.

In such a configuration, UEs 120, 130 and 140 have to connect to the network via a repetition number of 8, but they actually only need a repetition number of 2 to ensure the signal quality. Similarly, UEs 150, 160 and 170 have to connect to the network via a repetition number of 32, but they actually only need a repetition number of 16 to ensure the signal quality. The total repetition number for all the UEs is 1×1+8×3+32×4=153.

Consider another CE level configuration in the cell 100 by adjusting the MCLs for classification. As indicated by the dash curves in FIG. 1, MCL0′ and MCL1′ are used instead of MCL0 and MCL1. With this configuration, UEs 110, 120, 130 and 140 having pathlosses less than MCL0′ are classified as CE0, UEs 150, 160 and 170 having pathlosses between MCL0′ and MCL1′ are classified as CE1, and UE 180 having a pathloss between MCL1′ and MCL2 is classified as CE2. The corresponding repetition numbers for CE0, CE1 and CE2 in this configuration can be set as 2, 16 and 32. As a result, the total repetition number for all the UEs is 2×4+16×3+32×1=88, which is much less than the total repetition number of 153 in the previous configuration and thus saves the resources in the cell 100.

Therefore, it can be seen that the thresholds for setting CE levels can significantly affect the resource usage in the cell, and inappropriate CE level configuration may cause a waste of resources. As resources are shared in the cell, it may be advantageous to configure the thresholds for CE levels by considering the distribution of the UEs in the cell (or more accurately, the probability distribution of a signal quality parameter of the UEs in the cell), such that the total usage of resources in the whole cell can be optimized.

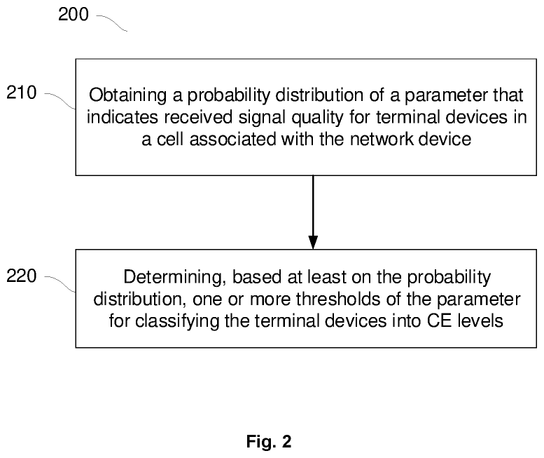

FIG. 2 is a flowchart illustrating a method 200 according to embodiments of the present disclosure. The method 200 can be performed at a network device, e.g., an eNB or a gNB, which is not limited.

At block 210, a probability distribution of a parameter for terminal devices in a cell associated with the network device is obtained. The parameter may indicate received signal quality. For example, the parameter may be SINR, RSRP, CQI, pathloss, and so on.

In an embodiment, it is preferable to use SINR as the parameter because SINR can more accurately reflect the channel condition than pathloss or RSRP and thus is more appropriate to be used to determine the required repetition number.

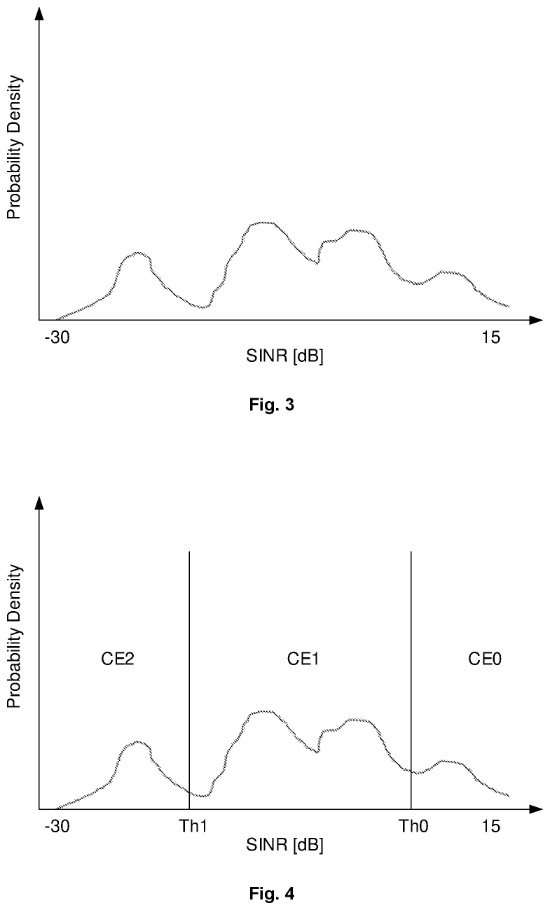

Refer to FIG. 3, which illustrates an exemplary probability distribution of SINR in a cell. As shown in FIG. 3, the horizontal axis represents SINR values and the vertical axis represents the probability density of SINR for the terminal devices in a cell. The curve thus may reflect the SINR distribution for the terminal devices in the cell, i.e., the number of terminals devices in each SINR interval. It should be noted that, although SINR is used here as an example, other parameters indicating received signal quality can also be used without limitation.

In an embodiment, at least one of the probability distribution of the parameter in downlink transmission and the probability distribution of the parameter in uplink transmission can be obtained. The probability distribution of the parameter in downlink or uplink transmission can be used alone or in combination to determine the thresholds for CE levels, which will be described later in more detail.

In an embodiment, the parameter is uplink SINR. The probability distribution of the uplink SINR may be obtained based on a received signal power and a noise and interference power for each of the terminal devices measured by the network device.

In another embodiment, the parameter is downlink SINR. The probability distribution of the downlink SINR may be obtained in several ways.

One way is to obtain the probability distribution of downlink SINR based on CQI reported by each of the terminal devices. More specifically, the terminal device may report CQI to the network device, e.g., in MSG3, and the network device can derive the downlink SINR for the terminal device based on the reported CQI. With the SINR from all the terminal devices, the network device can obtain the probability distribution of downlink SINR in the cell.

Alternatively, the probability distribution of downlink SINR may be obtained based on one or more Acknowledgement (ACK) or Negative Acknowledgement (NACK) messages from each of the terminal devices. More specifically, for each terminal device, the network device may initially set a plurality of downlink SINR candidates (e.g., −12 dB to 24 dB with an increment of 1 dB) and their respective probability values, and adjust the probability values for the SINR candidates according to whether an ACK message or a NACK message is received from the terminal device. For example, in response to an ACK message from the terminal device that is associated with downlink transmission with a first Modulation and Coding Scheme (MCS) corresponding to a first SINR (e.g., 5 dB), the probability value for at least one of the SINR candidates can be adjusted such that a sum of the respective probability values for those SINR candidates higher than or equal to the first SINR (e.g., 5 dB) increases. On the other hand, in response to a NACK message from the terminal device that is associated with downlink transmission with a second MCS corresponding to a second SINR (e.g., 7 dB), the probability value for at least one of the SINR candidates can be adjusted such that a sum of the respective probability values for those SINR candidates lower than the second SINR (e.g., <7 dB) increases. It would be appreciated that the adjustment may be subject to the constraint that the sum of the probability values for all the SINR candidates shall be 1. In this way, the downlink SINR for each terminal device can be estimated to be the SINR candidate having the highest probability value. More details of estimating downlink SINR based on ACK/NACK messages from terminal device are described in PCT Patent Application No. PCT/CN2019/086419, entitled “Method and Network Device for Link Adaption”, filed on May 10, 2019, the content of which is hereby incorporated by reference in its entirety. With the estimated downlink SINR for each terminal device, the probability distribution of downlink SINR for all the terminal devices can be obtained.

In yet another embodiment, the parameter is RSRP, and the probability distribution of RSRP may be obtained based on at least one of RSRP reported by each of the terminal devices (e.g., in MSGS) and Power Headroom reported by each of the terminal devices. Although RSRP is not as accurate as SINR in terms of reflecting the channel condition, it may be better compatible with the existing NB-IoT standard because RSRP is used for determining the CE level for the terminal device according to the existing NB-IoT standard.

Refer back to FIG. 2. At block 220, one or more thresholds of the parameter are determined based at least on the probability distribution. The one or more thresholds are used for classifying the terminal devices in the cell into CE levels.

In an embodiment, the repetition numbers each associated with one of the CE levels are also determined based at least on the probability distribution. Usually, a larger repetition number is associated with a CE level having worse signal quality.

According to an embodiment, the one or more thresholds of the parameter and the repetition numbers are determined in such a way that a sum of repetition numbers for the terminal devices in the cell is minimized for a predetermined number of the CE levels.

An example of this embodiment will be described below with respect to FIG. 4. FIG. 4 is similar to FIG. 3 but with indications of different CE levels and SINR thresholds added.

Assume three CE levels, CE0, CE1 and CE2, are used in this example, as shown in FIG. 4. Then two thresholds of SINR, Th0 and Th1, for dividing the SINR into the three CE levels can be tentatively set, and the sum of the repetition numbers for all the terminal devices can be calculated. In the calculation, the repetition number for each CE level can be determined by the worst SINR to be supported in the CE level. The mapping from SINR to repetition number can be obtained based on link level simulation results. The calculation can be iteratively performed for different tentative SINR thresholds until the sum of the repetition numbers for all the terminal devices is minimized. Then the optimized SINR thresholds and corresponding repetition numbers can be determined as those corresponding to the minimized sum.

Mathematically, the above described optimization can be represented by the minimization of, e.g., the following expression:

$${\sum }_{i = 0}^{m} {P}_{i} * {R}_{i}$$

where m is the number of CE levels, Pᵢ is the cumulative probability density of SINR for a respective CE level i, and Rᵢ is the repetition number of the respective CE level i, which is determined by the worst SINR to be supported in the CE level i, as described above. Different tentative SINR thresholds can be set to calculate the result of the above expression until the result is minimized. In the optimization, various tentative algorithms can be used to minimize the expression, which is not limited.

It should be noted that, although three CE levels are shown in FIG. 4, other numbers of CE levels can also be used. Different optimization results may be obtained for different numbers of CE levels. Usually, the minimized sum of repetition numbers may be smaller for a larger number of CE levels and thus more resources in the cell can be saved, but on the other hand, this may increase the system complexity.

As mentioned above, the probability distribution of the parameter in downlink or uplink transmission can be used alone or in combination to determine the thresholds for CE levels and also the repetition numbers. For example, the downlink SINR distribution and the uplink SINR distribution may be different, and thus the optimized SINR thresholds determined from these two distributions may be different. If both the downlink and uplink SINR distributions are obtained at the network device, the network device can choose the SINR thresholds to be used based on, e.g., which resources, downlink resources or uplink resources, are more valuable. In another example, the network device can make a compromise between the SINR thresholds determined based on the downlink and the uplink distributions.

According to an embodiment, the method 200 may further include transmitting information related to the one or more thresholds of the parameter and the repetition numbers to the terminal devices in the cell. The transmitted information may be the thresholds per se and the repetition numbers, or may be other information related to or derived from the thresholds and the repetition numbers. For example, if the parameter is RSRP, then the information may be RSRP thresholds and the associated repetition numbers. If the parameter is SINR, then the information may be SINR thresholds and the associated repetition numbers. Alternatively, the information may be RSRP thresholds derived from the SINR thresholds and the associated repetition numbers, because the terminal device may need the RSRP thresholds to determine its CE level in a particular scenario, e.g., according to existing NB-IoT standard.

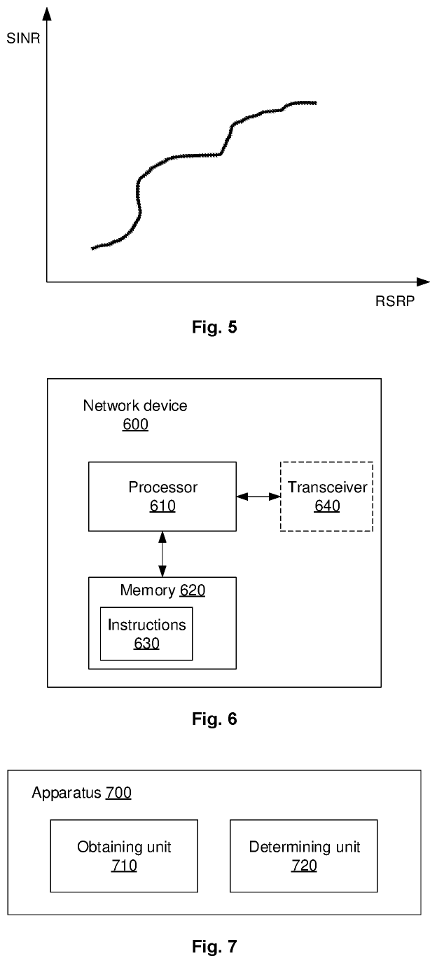

Accordingly, in an embodiment, the method 200 may further include determining one or more thresholds of RSRP corresponding to the one or more thresholds of SINR. The one or more thresholds of RSRP may be determined according to a relationship between RSRP and SINR for the terminal devices in the cell. As an example, FIG. 5 shows an exemplary curve of SINR versus RSRP in a cell, which can be used to derive the thresholds of RSRP corresponding to the thresholds of SINR. The relationship may be derived based at least on information reported by the terminal devices in the cell. For example, the SINR and RSRP of each terminal device can be obtained according to the embodiments as described above, and the relationship between them can be derived accordingly.

According to an embodiment, the method 200 can be repeated regularly to update the one or more thresholds of the parameter and the repetition numbers. This is especially useful for using SINR as the parameter because the noise and interference could change over time and thus the SINR will change during operation. The update may be performed not very frequently. For example, the period can be in the order of hours. Therefore, data about the probability distribution of the parameter can be stored in a place outside the baseband board (BB) and the optimization of thresholds for the CE levels can be performed outside the BB as well. As a result, the normal function in the BB will not be affected.

It should be noted that, although the method 200 is mainly described with respect to NB-IoT as an example, the method 200 can also be implemented in any other suitable networks, which is not limited.

FIG. 6 is a block diagram of a network device 600 according to embodiments of the present disclosure, which can be, e.g., the network device as described in connection with FIG. 2.

The network device 600 includes a processor 610 and a memory 620. Optionally, the network device 600 may further include a transceiver 640 coupled to the processor 610. The memory 620 contains instructions 630 executable by the processor 610 to cause the network device 600 to perform the actions of the method 200. Particularly, the memory 620 may contain instructions that, when executed by the processor 610, cause the network device 600 to obtain a probability distribution of a parameter that indicates received signal quality for terminal devices in a cell associated with the network device 600, and determine, based at least on the probability distribution, one or more thresholds of the parameter for classifying the terminal devices into CE levels.

According to an embodiment, the determining step may further include determining, based at least on the probability distribution, repetition numbers each associated with one of the CE levels.

According to an embodiment, the one or more thresholds of the parameter and the repetition numbers may be determined in such a way that a sum of repetition numbers for the terminal devices in the cell is minimized for a predetermined number of the CE levels.

According to an embodiment, obtaining the probability distribution of the parameter may comprise at least one of: obtaining the probability distribution of the parameter in downlink transmission; and obtaining the probability distribution of the parameter in uplink transmission.

According to an embodiment, the one or more thresholds of the parameter and the repetition numbers may be determined based on: the probability distribution of the parameter in downlink transmission; and/or the probability distribution of the parameter in uplink transmission.

According to an embodiment, the operations performed by the network device 600 may be repeated regularly to update the one or more thresholds of the parameter and the repetition numbers.

According to an embodiment, the parameter may be SINR.

According to an embodiment, the parameter may be downlink SINR, and the probability distribution of the downlink SINR may be obtained based on a CQI reported by each of the terminal devices.

According to an embodiment, the parameter may be downlink SINR, and the probability distribution of the downlink SINR may be obtained based on one or more ACK or NACK messages from each of the terminal devices.

According to an embodiment, the parameter may be uplink SINR, and the probability distribution of the uplink SINR may be obtained based on a received signal power and a noise and interference power for each of the terminal devices measured by the network device 600.

According to an embodiment, the memory 620 may further contain instructions that, when executed by the processor 610, cause the network device 600 to determine one or more thresholds of RSRP corresponding to the one or more thresholds of SINR.

According to an embodiment, the one or more thresholds of RSRP may be determined according to a relationship between RSRP and SINR for the terminal devices in the cell. The relationship may be derived based at least on information reported by the terminal devices in the cell.

According to an embodiment, the parameter may be RSRP, and the probability distribution of RSRP may be obtained based on at least one of RSRP reported by each of the terminal devices and Power Headroom reported by each of the terminal devices.

According to an embodiment, a larger repetition number may be associated with a CE level having worse signal quality.

According to an embodiment, the network device 600 may be configured to support NB-IoT.

According to an embodiment, the memory 620 may further contain instructions that, when executed by the processor 610, cause the network device 600 to transmit information related to the one or more thresholds of the parameter and the repetition numbers to the terminal devices in the cell.

It should be noted that, more details described with reference to FIGS. 2-5 also apply here and may be omitted.

The memory 620 may be of any type suitable to the local technical environment and may be implemented using any suitable data storage technology, such as semiconductor based memory terminal devices, magnetic memory terminal devices and systems, optical memory terminal devices and systems, fixed memory and removable memory, as non-limiting examples.

The processor 610 may be of any type suitable to the local technical environment, and may include one or more of general purpose processors, special purpose processors (e.g., Application Specific Integrated Circuit (ASICs)), microprocessors, digital signal processors (DSPs) and processors based on multicore processor architecture, as non-limiting examples.

FIG. 7 is a block diagram of an apparatus 700 according to embodiments of the present disclosure, which can be configured to perform the method 200 as described in connection with FIG. 2.

The apparatus 700 may include an obtaining unit 710 and a determining unit 720. The obtaining unit 710 may be configured to obtain a probability distribution of a parameter that indicates received signal quality for terminal devices in a cell associated with the network device, and the determining unit 720 may be configured to determine, based at least on the probability distribution, one or more thresholds of the parameter for classifying the terminal devices into CE levels.

The apparatus 700 can be implemented as the network device 600 or as a software and/or a physical device within the network device 600 or communicatively coupled to the network device 600.

Further details about the apparatus 700 are similar to those described with respect to FIGS. 2-5 and are omitted here.

The units as described in FIG. 7 may be implemented as software and/or hardware, or a device comprising the software and/or the hardware, which is not limited. For example, they can be implemented as computer readable programs that can be executed by a processor. Alternatively, they can be implemented as processing circuitry such as ASICs and/or field programmable gate arrays (FPGAs).

The present disclosure may also provide computer readable media having instructions thereon. The instructions, when executed by a processor of a network device or a terminal device, cause the network device or terminal device to perform the method according to the embodiments as described above. The computer readable media may include computer-readable storage media, for example, magnetic disks, magnetic tape, optical disks, phase change memory, or an electronic memory terminal device like a random access memory (RAM), read only memory (ROM), flash memory devices, CD-ROM, DVD, Blue-ray disc and the like. The computer readable media may also include computer readable transmission media (also called a carrier), for example, electrical, optical, radio, acoustical or other form of propagated signals-such as carrier waves, infrared signals, and the like.

The present disclosure may also provide computer program products including instructions. The instructions, when executed by a processor of a network device or a terminal device, cause the network device or terminal device to perform the method according to the embodiments as described above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, units, apparatus, systems, techniques or methods described herein may be implemented in, as non-limiting examples, hardware, software, firmware, special purpose circuits or logic, general purpose hardware or controller or other computing devices, or some combination thereof.

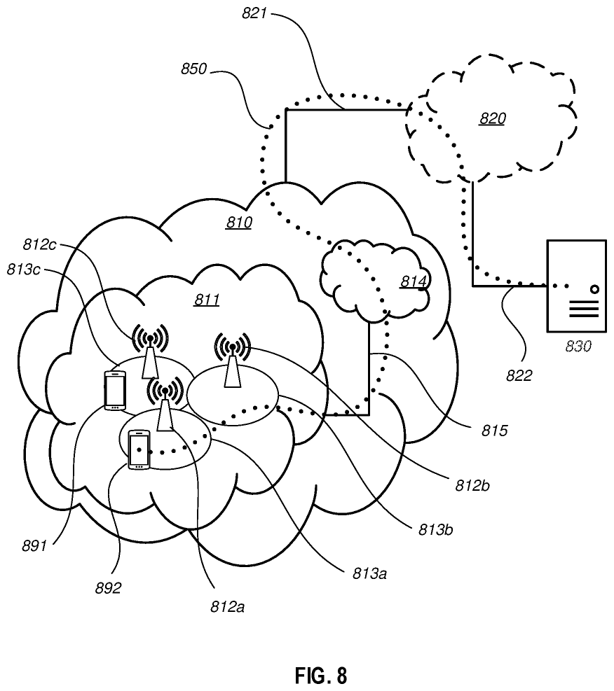

With reference to FIG. 8, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first user equipment (UE) 891 located in coverage area 813c is cond to wirelessly connect to, or be paged by, the corresponding base station 812c. A second UE 892 in coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. The connections 821, 822 between the telecommunication network 810 and the host computer 830 may extend directly from the core network 814 to the host computer 830 or may go via an optional intermediate network 820. The intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 8 as a whole enables connectivity between one of the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, a base station 812 may not or need not be informed about the past routing of an incoming downlink communication with data originating from a host computer 830 to be forwarded (e.g., handed over) to a connected UE 891. Similarly, the base station 812 need not be aware of the future routing of an outgoing uplink communication originating from the UE 891 towards the host computer 830.

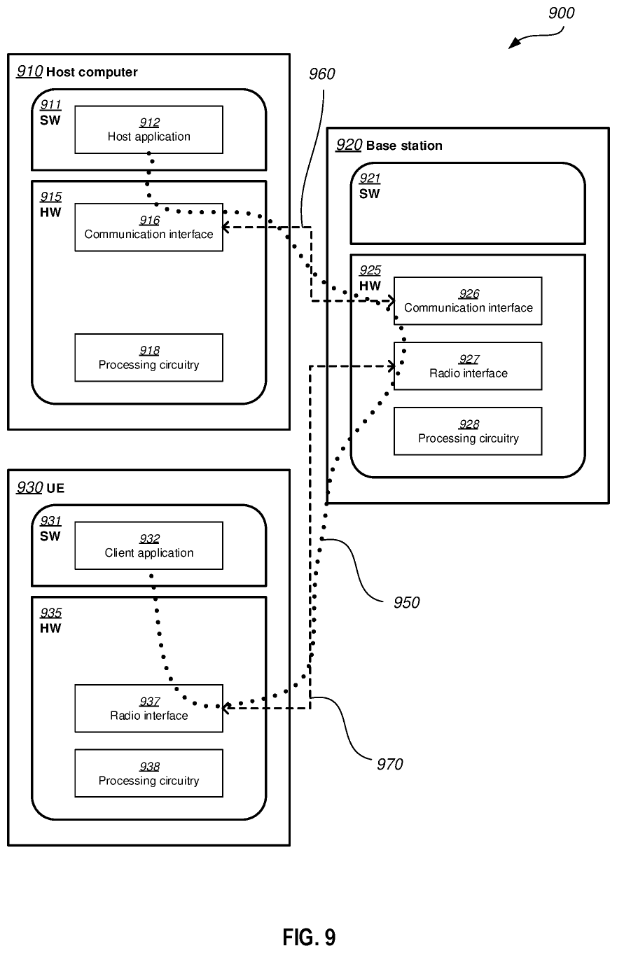

Example implementations, in accordance with an embodiment, of the UE, base station and host computer discussed in the preceding paragraphs will now be described with reference to FIG. 9. In a communication system 900, a host computer 910 comprises hardware 915 including a communication interface 916 configured to set up and maintain a wired or wireless connection with an interface of a different communication device of the communication system 900. The host computer 910 further comprises processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as a UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with a UE 930 located in a coverage area (not shown in FIG. 9) served by the base station 920. The communication interface 926 may be configured to facilitate a connection 960 to the host computer 910. The connection 960 may be direct or it may pass through a core network (not shown in FIG. 9) of the telecommunication system and/or through one or more intermediate networks outside the telecommunication system. In the embodiment shown, the hardware 925 of the base station 920 further includes processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, base station 920 and UE 930 illustrated in FIG. 9 may be identical to the host computer 830, one of the base stations 812a, 812b, 812c and one of the UEs 891, 892 of FIG. 8, respectively. This is to say, the inner workings of these entities may be as shown in FIG. 9 and independently, the surrounding network topology may be that of FIG. 8.

In FIG. 9, the OTT connection 950 has been drawn abstractly to illustrate the communication between the host computer 910 and the use equipment 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

The wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the efficiency of resource usage and thereby provide benefits such as better save network resources.

A measurement procedure may be provided for the purpose of monitoring data rate, latency and other factors on which the one or more embodiments improve. There may further be an optional network functionality for reconfiguring the OTT connection 950 between the host computer 910 and UE 930, in response to variations in the measurement results. The measurement procedure and/or the network functionality for reconfiguring the OTT connection 950 may be implemented in the software 911 of the host computer 910 or in the software 931 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer's 910 measurements of throughput, propagation times, latency and the like. The measurements may be implemented in that the software 911, 931 causes messages to be transmitted, in particular empty or ‘dummy’ messages, using the OTT connection 950 while it monitors propagation times, errors etc.

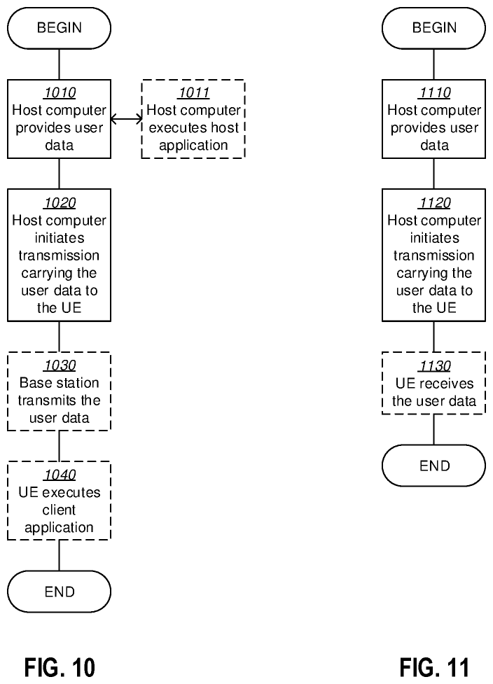

FIG. 10 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 10 will be included in this section. In a first step 1010 of the method, the host computer provides user data. In an optional substep 1011 of the first step 1010, the host computer provides the user data by executing a host application. In a second step 1020, the host computer initiates a transmission carrying the user data to the UE. In an optional third step 1030, the base station transmits to the UE the user data which was carried in the transmission that the host computer initiated, in accordance with the teachings of the embodiments described throughout this disclosure. In an optional fourth step 1040, the UE executes a client application associated with the host application executed by the host computer.

FIG. 11 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 11 will be included in this section. In a first step 1110 of the method, the host computer provides user data. In an optional substep (not shown) the host computer provides the user data by executing a host application. In a second step 1120, the host computer initiates a transmission carrying the user data to the UE. The transmission may pass via the base station, in accordance with the teachings of the embodiments described throughout this disclosure. In an optional third step 1130, the UE receives the user data carried in the transmission.

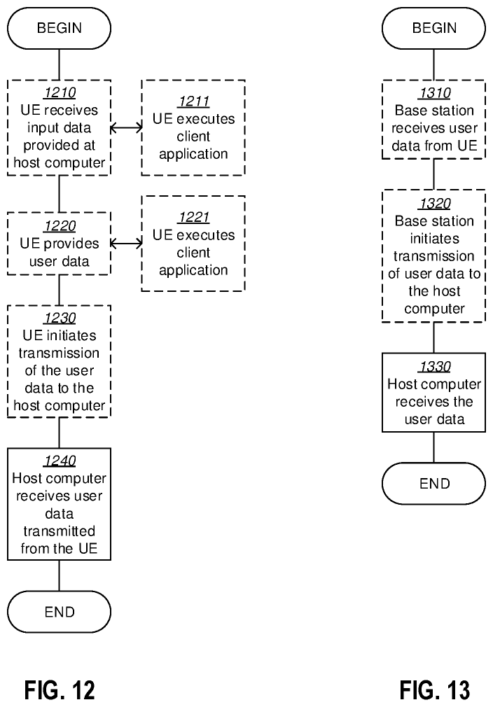

FIG. 12 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 12 will be included in this section. In an optional first step 1210 of the method, the UE receives input data provided by the host computer. Additionally or alternatively, in an optional second step 1220, the UE provides user data. In an optional substep 1221 of the second step 1220, the UE provides the user data by executing a client application. In a further optional substep 1211 of the first step 1210, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1230, transmission of the user data to the host computer. In a fourth step 1240 of the method, the host computer receives the user data transmitted from the UE, in accordance with the teachings of the embodiments described throughout this disclosure.

FIG. 13 is a flowchart illustrating a method implemented in a communication system, in accordance with one embodiment. The communication system includes a host computer, a base station and a UE which may be those described with reference to FIGS. 8 and 9. For simplicity of the present disclosure, only drawing references to FIG. 13 will be included in this section. In an optional first step 1310 of the method, in accordance with the teachings of the embodiments described throughout this disclosure, the base station receives user data from the UE. In an optional second step 1320, the base station initiates transmission of the received user data to the host computer. In a third step 1330, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method at a network device, comprising:
obtaining a probability distribution of a parameter that indicates received signal quality for terminal devices in a cell associated with the network device; and
determining, based at least on the probability distribution, one or more thresholds of the parameter for classifying the terminal devices into coverage enhancement (CE) levels.

2. The method of claim 1, wherein the determining step further comprises: determining, based at least on the probability distribution, repetition numbers each associated with one of the CE levels.

3. The method of claim 2, wherein the one or more thresholds of the parameter and the repetition numbers are determined in such a way that a sum of repetition numbers for the terminal devices in the cell is minimized for a predetermined number of the CE levels.

4. The method of claim 2, wherein obtaining the probability distribution of the parameter comprises at least one of: obtaining the probability distribution of the parameter in downlink transmission; and obtaining the probability distribution of the parameter in uplink transmission.

5. The method of claim 4, wherein the one or more thresholds of the parameter and the repetition numbers are determined based on: the probability distribution of the parameter in downlink transmission; and/or the probability distribution of the parameter in uplink transmission.

6. The method of claim 2, wherein the method is repeated regularly to update the one or more thresholds of the parameter and the repetition numbers.

7. The method of claim 1, wherein the parameter is Signal to Interference plus Noise Ratio (SINR).

8. The method of claim 7, wherein the parameter is downlink SINR, and the probability distribution of the downlink SINR is obtained based on a Channel Quality Indicator (CQI) reported by each of the terminal devices.

9. The method of claim 7, wherein the parameter is downlink SINR, and the probability distribution of the downlink SINR is obtained based on one or more Acknowledgement (ACK) or Negative Acknowledgement (NACK) messages from each of the terminal devices.

10. The method of claim 7, wherein the parameter is uplink SINR, and the probability distribution of the uplink SINR is obtained based on a received signal power and a noise and interference power for each of the terminal devices measured by the network device.

11. The method of claim 7, further comprising:
determining one or more thresholds of Reference Signal Received Power (RSRP) corresponding to the one or more thresholds of SINR.

12. The method of claim 11, wherein the one or more thresholds of RSRP are determined according to a relationship between RSRP and SINR for the terminal devices in the cell, wherein the relationship is derived based at least on information reported by the terminal devices in the cell.

13. The method of claim 1, wherein the parameter is RSRP, and wherein the probability distribution of RSRP is obtained based on at least one of RSRP reported by each of the terminal devices and Power Headroom reported by each of the terminal devices.

14. The method of claim 1, wherein a larger repetition number is associated with a coverage enhancement (CE) level having worse signal quality.

15. The method of claim 1, wherein the network device is configured to support a Narrowband Internet of Things (NB-IoT).

16. The method of claim 2, further comprising: transmitting information related to the one or more thresholds of the parameter and the repetition numbers to the terminal devices in the cell.

17. A network device, comprising:
a processor;
a memory configured to store instructions, wherein the instructions, when executed by the processor, cause the network device to:
obtain a probability distribution of a parameter that indicates received signal quality for terminal devices in a cell associated with the network device; and
determine, based at least on the probability distribution, one or more thresholds of the parameter for classifying the terminal devices into coverage enhancement (CE) levels.

18. The network device of claim 17, wherein the memory is further configured to store instructions that, when executed by the processor, cause the network device to perform the method-RN) according to claim 2.

19. A computer-readable storage medium having instructions stored thereon, wherein the instructions, when executed by a processor of a network device, cause the network device to perform the method according to claim 1.

20. (canceled)
